(19) United States
(12) Patent Application Publication
(10) Pub. No.: US 2016/0298605 A1
(43) Pub. Date: Oct. 13, 2016

(54) Self-Regulating Wind Amplifier and Brake System

(71) Applicants: Douglas Brendle, Cheyenne, WY (US); Stephen N. Brinkerhoff, Cheyenne, WY (US)

(72) Inventors: Douglas Brendle, Cheyenne, WY (US); Stephen N. Brinkerhoff, Cheyenne, WY (US)

(21) Appl. No.: 15/069,223

(22) Filed: Mar. 14, 2016

Related U.S. Application Data
(60) Provisional application No. 62/133,145, filed on Mar. 13, 2015.
(60) Provisional application No. 62/134,056, filed on Mar. 17, 2015.

(51) Int. Cl. F03D 7/04; F03D 9/00; F03D 3/06; F03D 7/02; F03D 3/00; F03D 3/04

(52) U.S. Cl. CPC F03D 7/041; F03D 3/005; F03D 3/0418; F03D 3/062; F03D 7/0244; F03D 7/0276; F03D 9/002

(57) ABSTRACT

The disclosed self-regulating wind amplifier and brake system utilizes self-adjustable louvers, forcing wind into the capture blades of a wind turbine. These louvers direct and compress incoming wind current increasing the wind speed internally before impacting the capture blades of the turbine increasing the produced torque to the generator shaft at lower wind speeds. The louvers redirect the wind current that would normally impact the shed side of the turbine and create drag reducing the turbine rpm and torque. As wind speeds reach a level that begin to exceed the capacity of the generator the wind itself will actuate the system that begins to close the louvers more and more as the wind speed increases intern constantly regulating the wind current allowed to enter into the system maintaining the optimal wind speed internally that impacts the turbine. During high winds that exceed the capacity of the regulating system the louvers will close completely shutting off all wind to the turbine and redirecting it around and past the outside of the self-regulating wind amplifier and brake system. A modular system with multiple turbines inline and stack is also disclosed. Finally, a self-regulating wind amplifier and brake system that is automatically controlled with sensors and actuator independent of or in conjunction with the self-regulating mechanism.

### CROSS REFERENCE APPLICATIONS

This application is a non-provisional application claiming the benefit of provisional application No. 62/133,145 filed Mar. 13, 2015 and provisional application No. 62/134,056 filed Mar. 17, 2015, the disclosures of which are hereby incorporated by reference for all purposes

### BACKGROUND

The ultimate goal of wind turbine design is to create a system that produces the most power in the most efficient manner. This can be accomplished when the system produces effective usable power while at the same time preventing the system from catastrophic failure and/or reduction in power output due to high wind events. Prior art technology regarding both issues has been primarily designed to produce power until high wind events occur. The most common methods to prevent catastrophic failure or cessation of power production during these high wind events is to dynamically brake the alternator/generator shaft from rotating or using a clutching device to slow down the rotation. Another method is to use a device that allows the shaft to free-spin, disconnecting the turbine from the alternator/generator shaft. In each of these methods there can be dangerous amounts of force from the wind current as this current contacts the turbine blades/louvers. Added to this is the cessation of power production or at least a significant reduction in power production.

The greatest problem with existing horizontal axis wind turbines (HAWTs) and vertical axis wind turbines (VAWTs) platforms is the passive nature of the designs. Generally, when wind encounters a turbine, there are three possible outcomes: (1) the wind is captured; (2) the wind is shed; or (3) the wind has a neutral impact. If the wind is captured, it can have either a positive impact, turning the blades and activating the generator, or a negative impact, pushing the blades in the opposing direction and affecting the ability of the turbine to rotate in a positive direction. The turbine either requires higher winds speeds than are normal to start turning the turbine against the generators resistant force or there is too high a wind than the generator to handle safely and will have to be shut down. In either case it is not producing power.

Existing HAWT and VAWT platforms do not direct wind. Rather, existing designs allow wind to make contact with the capture blades and the shed or neutral blades at the same time. The wind impact on the shed and neutral blades can generate momentary negative force to the shaft that turns the blade in the opposite of the desired direction. This negative force fights against the positive force and desired rotational direction, which in turn diminishes the speed and torque potential of the turbine as a whole and creates a pulsing affect in the rpm speed and energy production levels. Typical VAWTs create positive and negative forces that are initially equal in exposure. During rotation, VAWT blades move into positions around the axis that create more negative force exposure and potential on the shed side than positive. When transitioning from the equal exposure to the greater negative exposure the louvers on each side of rotation axis fight against each other to turn the turbine in two different directions, creating a pulsing affect in energy production. The capture side exposure is increased by its shape, which captures more wind than it deflects, and the shed side deflects more air than it captures, thereby forcing the turbine to turn in the positive direction. But as long as the shed side creates momentary or constant capture surfaces in the shed position, an ever-present choking or braking affect is created. This braking affect reduces the potential of positive forces and directional speed (rpms), thereby limiting the production of power from the typical VAWT. The transition between more and less negative forces creates the fast and slow pulsing actions of the turbine head in a constant wind speed.

These characteristics of typical VAWTs limit the production of converted torque and power, slowing down the acceptance and application of VAWTs as viable energy alternatives compared to HAWT systems. Currently both VAWT and HAWT turbines must be very large in size to produce a viable level of torque to turn a large generator and therefore are very demanding on the environment, both by creating large footprints and by having unacceptable aesthetic values.

The foregoing example of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tool and methods, which are meant to be exemplary and illustrative, not limiting in scope. In various embodiments, one or more of the above-described problems have been reduced or eliminated, while other embodiments are directed to other improvements.

A self-regulating wind amplifier and brake system is disclosed that is actuated by the wind and self-adjusts as wind speeds increase and decrease, producing more torque at lower wind speeds, and/or regulating high winds down to a lower optimal wind speed before impacting the turbines blades. Additionally, if wind speeds are too high to regulate down to an optimal/safe speed, the high winds themselves will close the louvers completely, shielding the turbine from any impact from the wind guarding it from over rotating the generator and damaging it. It has a positive aesthetic appeal, produces little to no noise and poses no noticeable wildlife danger. The disclosed self-regulating wind amplifier and brake system has adjustable louvers to direct wind toward the positive drive capture blades of a wind turbine.

These louvers direct and increase the wind speed to conversion surfaces of the turbine, producing more leverage and torque. The louvers also direct wind away from shedding/drag surfaces of the turbine eliminating all shed/drag forces that would slow down the turbine rpms and diminish the potential torque to the generator shaft.

The louvers are adjustable, allowing control over the amount of wind that is permitted to impact the turbine and can be closed when winds are too high for safe operation of the generator, eliminating the need for a brake system. The high wind capture ladle that sits on top of the system turns freely and independent of the louver pivoting rods and will follow the changing direction of the wind buy quickly rotating 360 degrees around the top plate of the column. The capture ladle acts as a wind vane and the wind captured by the ladle adjusts the louvers with respect to the current wind speed.

The present design not only prevents high wind events from causing damage to the turbine and/or the alternator/generator during high wind events, it also controls the wind current in such a way that the power production is increased during normal wind and (maintained for longer in?) high wind. The present design allows for maximum power production from wind turbines as well as the most secure way to prevent damage to the turbine during high wind events by preventing the high wind forces from impacting the turbine blades/louvers. The present design directs force of the wind to the proper location on the turbine louvers/blades as well as controlling the amount force from the wind that can impact the turbine louvers/blades. It is reliable, modifiable and effective. The present design utilizes the wind as the energy source that regulates the amount of wind current contacting the turbine blades. By utilizing the wind as a proactive force for both power production and damage control, the present design regulates both the quality (direction of wind current) and quantity (amount) of wind current.

This design eliminates nearly all negative force exposure and potential on the shed side of the turbine inside it, therefore reducing or eliminating the pulse potential and increasing the effectiveness the positive drive force by reducing or eliminating its opposing forces. The effective positive drive force is also increased by directing the wind that normally impacts the shed side of the turbine toward the capture side and into the capture blades of the turbine increasing the amount of overall wind force that impacts each capture blade of the turbine. When this redirected shed wind is brought into the amplifier chamber and redirected it is compressed with the wind that is naturally directed to the capture blades, and as a result of the compression the wind speed within the amplifier chamber is increased, generating a much greater positive drive force impacting the capture blades. This result in the production of more torque on the generator shaft resulting in higher generator rpms at a lower wind speed. The amplification of internal wind speed produces sufficient torque to start power production at wind speeds that are typically too low to overcome the inertia of the generator. When the inertial force of the generator is equaled and then exceeded by the torque produced by the wind on the turbine, the turbine will begin to turn and then reach an rpm that will begin to produce measurable power.

As an integrated system, the amplification increases the torque generated at lower winds speeds closer to optimal speeds, and regulates higher than optimal wind speeds down to an appropriate torque and helps prevent the system from exceeding the optimal internal torque. This system allows the wind turbine to produce more and consistent power regardless to the external wind speed conditions. thereby producing more power than prior art systems in low wind conditions and continuing to produce power during high wind conditions that would normally force a turbine to brake and stop production entirely.

A turbine can suffer a tremendous amount of structural stress and damage when the shaft is abruptly stopped, but the strong high winds continue to impact the turbine blades. The turbine blades are now a solid object, having to absorb all the winds force with no way to roll any of it off. This can either tear apart the turbine or bend or uproot the post or column it is attached to. The present design also reduces or eliminates the need to disconnect the turbine from the generator and therefore free spin, which can potentially tear the turbine apart. The system also eliminates the need for the alternative clutch that when engaged produces a lot of friction force and heat which can cause the clutch plates to slip and relieve drive force applied to the generator shaft which could result in clutch failure or fire.

As the wind speed increases and decreases above the safe/optimal operating wind speed, the high wind capture ladle actively adjusts the louvers to regulate the force of the wind currently impacting the blade to not exceed the optimal turbine rpm and avoiding any over rotation of the turbine and generator

This system shelters and protects the turbine and its operation is driven by the wind itself. Low winds cause the amplifier/brake louvers to open fully and amplify turbine torque by directing more force to the turbine capture blades Any wind at a higher speed than a chosen optimal speed impacting the device causes the amplifier/brake louvers to regulate by closing the louvers in proportion to the wind speed, thereby choking the amount of wind entering into the system down to within the optimal range for wind force impacting the turbine. When the wind speed is too high and can no longer be regulated down, the amplifier/brake louvers close completely cutting off any force being applied to the turbine at which time the turbine is allowed to naturally decelerate as the force impacting the blades decreases to zero. The closed amplifier louvers take all the wind force and deflect it away from the turbine and around the outside of the system.

Other brakes actually stop the generator/turbine shaft and must be released manually or by a dynamic controller for the turbine to get back into service. This is an extreme operating inconvenience and a large amount energy production missed. The present wind actuated regulator and braking system does not stop the shaft, and is real time responsive to the wind speed and instead controls the incoming wind speed.

This system can be made in such a manner the louvers encircle the turbine or can be arranged in line with one another creating a wall of wind direction that the high wind capture ladle can actively adjust all the in line louvers equally or some more than others at the same time. The system can also incorporate both the encircling and inline louvers.

This system enables the turbine to start, or cut-in, at much lower wind speeds and continue to safely produce power at what is normally too high a wind speed. When wind speeds exceed the system's ability to regulate it down and maintain it at the optimal internal speed, it can shut itself down with no damage to the turbine. It can immediately open and reengage the turbine the as soon as the wind drops to a speed that can be regulated down to within an optimal range and resume power production with very little to no loss of power production. In most cases this full closure of the system due to excessively high winds could be just a matter of seconds before the wind drops and the louvers open, allowing a regulated amount of wind back into the system to drive the turbine. Excessive wind speeds are typically generated momentarily via gusts of wind, not constant wind. This real-time self-regulating system reacts with the ever-changing wind allowing it to be utilized in places and environments that would normally require high levels of constant maintenance, or would not permit turbine use at all.

Additional controls can be implemented to actuate the high wind capture ladle and/or the pressure plate via digital computer commands controlling a screw ball drive to apply force instead of the wind to close the louvers and shut down the system. This can be prompted by, but not limited to, metered winds speeds, potential threats, and when backup batteries have reached their charging capacity to avoid overloading the batteries. This can eliminate the need for power dumping, battery damage and even injury.

A self-regulating wind amplifier and brake system according to the present disclosure may also include controls to automatically adjust the intake and exhaust openings of the louvers based upon external wind speed, thereby reducing the potential for damage to the turbine and/or generator at high wind speeds. The controls may also be programmed to monitor wind speeds and make automatic adjustments to the intake and exhaust openings of the louvers to maintain a more constant turbine rpm.

A tower for mounting a self-regulating wind amplifier and brake system with wind turbine(s) inside it is also disclosed. The disclosed tower is designed to house a generator or alternator at ground level, if desired. The configuration of the amplifier louvers and column frame would direct the current of a lightning strike to the outside of the tower and down and along the amp blade and column support frame and into the ground, directing all current away and shielding it from the generator shaft protecting the generator and the home/facility form the strike. The generator shaft is not connected to the amplifier/brake shaft and therefore the lightning strike current would not travel through the generator shaft bearing or the generator and melt or fuse them together disabling the turbine.

An integrated adjustable wind directional amplifier for use with a wind turbine is also disclosed. The adjustable wind directional amplifier directs the flow of wind to the optimum location for capture surfaces. The adjustable wind directional amplifier can be mounted on the ground as a wall-like structure. It may also be mounted on a tower. The adjustable wind directional amplifier, according to the present disclosure, can be used with multiple wind turbines. When used with multiple wind turbines, the adjustable wind directional amplifier may be used to focus more or less airflow to one or more turbines, thereby selectively controlling the output of all the turbines collectively or individually. Incorporating an adjustable wind directional amplifier allows turbines to be placed inside a building. The adjustable wind directional amplifier is stationary, and is controlled via adjustable louvers. These louvers can be manually controlled or electronically manipulated to increase or decrease the rotation of the wind turbines and torque generated, and can ultimately be used to maintain a constant rotation speed and torque regardless of the outside wind speeds. The louvers can be closed to shut off all air flow to the turbine, stopping the turbine completely, regardless of the outside wind speeds.

The adjustable wind directional amplifier can be profiled or externally shaped, and powder coated to compliment the surroundings. The inside or exhaust side of the amplifier can be filtered with a screening material to protect the turbine from impact from flying debris or wildlife, as well as creating a safety barrier that does not allow unauthorized access into the turbine area for people or animals.

This is a self-regulating wind amplifier and brake consisting of a structure comprising connected louvers surrounding the turbine(s) such that all or nearly all of the air current is directed to the wind turbine capture blades and away from the opposing/shed wind turbine blades. The structure having a top plate and bottom plate encompassing the turbine and tower, and the louvers of the amplifier pivotally mounted at the top plate and or bottom plate with a blade control arm connecting each amplifier louver at the pivot point to the control arm plate The control arm plate is fixed to the pressure plate drive tube, and the pressure plate drive tube surrounding the amplifier and brake shaft is fixed to the high wind regulator pressure plate. The high wind regulator pressure plate's vertical movement is controlled by the pressure wheel, which is connected to the high wind capture ladle. The high wind capture ladle is hinged to the pressure wheel at the ladle arm pivot point;

Wind current contacts the high wind capture ladle, causing it to face into the wind as the end or pressure wheel moves around the high wind regulator pressure plate. As the force of the wind current contacting the high wind capture ladle increases, the high wind regulator pressure plate is forced downward. The high wind pressure plate is fixed to the pressure plate drive tube and it surrounds the amplifier and brake shaft and is fixed to the control arm plate.

The control arm plate sits atop the calibrated compression spring or multiple springs, and the spring(s) is calibrated based on the dynamics of the turbine size and alternator/generator capabilities and are positioned below the control arm plate and atop of the stationary spring block. As the calibrated compression spring moves downward, the louver control arms connected to each louver at a point on each louver near its pivot point and at the control arm plate, closes the amplifier louvers by pulling all the louvers connecting points inward toward the center of the drive tube rotating the louvers about their axis'. The inward movement of these louvers reduces the wind current contacting the turbine capture blades as it reduces the open space between each of the louvers.

The amplifier louvers can be a wide range of widths, but there will be a minimal size and spacing determined the scale of the turbine as not to impede the wind entering the turbine. The compression spring force is also variable depending on the max rpm of the generator and when it is desired to start regulating or reducing the air supply to the turbine blades. The regulator brake is illustrated using rods attached to each louver giving equal closing force to each at the same time. It could also be done with a screw drive or geared system. The current method offers the least amount of wear and maintenance and moving parts.

Once the wind speed reaches the maximum force, based on the dynamics of the wind turbine and alternator/generator capabilities, the wind amplifier and brake louvers close completely, preventing the force of the wind from contacting the turbine blades which prevents catastrophic damage to the system.

Conversely, as the winds speed diminishes, the calibrated compression spring decompresses and the amplifier louvers open respectively, increasing the wind force contacting the turbine capture blades. At a point where the wind speed decreases enough that the louvers open to their optimal position allowing the maximum wind forces to enter through the louvers and then be directed and amplified to the turbine capture blades, while always directing wind away from the opposing/shed turbine blades.

As the wind speed increases and decreases above the safe/optimal operating wind speed high wind capture ladle actively adjusts for louvers to regulate the wind current not to exceed the optimal turbine rpm and avoiding any over rotation of the turbine and generator.

With wind speeds less than optimal, the louvers direct the force of the wind that would normally contact the turbine's shedding surfaces to the capture blades of the turbine of its blades. This reduces the opposing/negative forces to the capture blades and prevents slowing down the rotation of the turbine, diminishing its potential energy production. Directing this additional force of the wind, along with the wind that is naturally headed in the direction of the turbine capture blades, to a select set of turbine blade or a single turbine blade creates a compressive force that accelerates the wind speed in the amplifier chamber to the turbine capture blade, there by amplifying the outside wind speed in the amplifier chamber to create higher levels of drive force and torque, generating high levels of power at a given wind speed;

The amplification of internal wind speed produces sufficient force and torque to start power production at wind speeds that are typically too low to overcome the resistant force of the generator. When the resistant force of the generator is equaled and then exceeded by the drive force of the wind, the turbine will begin to turn and then reach an rpm that will begin to produce measurable power.

This self-controlling system helps create the most optimum and consistent wind force available to contact the wind turbine system. This allows it to reach an optimal generator rpm faster at lower wind speeds and maintains the optimal speed longer without allowing it to exceed the generators capacity regardless to the outside wind speeds.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a diagonal top view of a prior art vertical shaft wind turbine generator and brake system.

FIG. 2 is a diagonal top view of a self-regulating wind amplifier and brake system.

FIG. 3 is a diagonal top view of a self-regulating wind amplifier and brake system labeling the parts of FIG. 1.

FIG. 4 is a diagonal top view of a self-regulating wind amplifier and brake system with the turbine/amplifier top and bottom plates removed for internal visibility.

FIG. 5 is a diagonal top view of a self-regulating wind amplifier and brake system with decorative eagle shaped wind vein added to side of the high wind capture ladle. The view also has the turbine/amplifier top plate and four brake blades and two blade pivot rods removed for visibility of internal parts.

FIG. 6 is a front view of a self-regulating wind amplifier and brake system showing the high wind capture ladle and wind amplifier & brake blades position at winds speeds at 0 to 40 mph.

FIG. 7 is a top view of a self-regulating wind amplifier and brake system showing the high wind capture ladle and wind amplifier & brake blades position at winds speeds at 0 to 40 mph.

FIG. 8 is a diagonal top view of a self-regulating wind amplifier and brake system showing the high wind capture ladle and wind amplifier & brake blades position at winds speeds at 0 to 40 mph.

FIG. 9 is a front view of a self-regulating wind amplifier and brake system showing the high wind capture ladle and wind amplifier & brake blades position at a wind speed of 50 mph.

FIG. 10 is a top view of a self-regulating wind amplifier and brake system showing the high wind capture ladle and wind amplifier & brake blades position at a wind speed of 50 mph.

FIG. 11 is a diagonal top view of a self-regulating wind amplifier and brake system showing the high wind capture ladle and wind amplifier & brake blades position at a wind speed of 50 mph.

FIG. 12 is a front view of a self-regulating wind amplifier and brake system showing the high wind capture ladle and wind amplifier & brake blades position at a wind speed of 65 mph.

FIG. 13 is a top view of a self-regulating wind amplifier and brake system showing the high wind capture ladle and wind amplifier & brake blades position at a wind speed of 65 mph.

FIG. 14 is a diagonal top view of a self-regulating wind amplifier and brake system showing the high wind capture ladle and wind amplifier & brake blades position at a wind speed of 65 mph.

FIG. 15 is a front view of a self-regulating wind amplifier and brake system showing the high wind capture ladle and wind amplifier & brake blades position at wind speeds of 70 to 200 mph.

FIG. 16 is a top view of a self-regulating wind amplifier and brake system showing the high wind capture ladle and wind amplifier & brake blades position at wind speeds of 70 to 200 mph.

FIG. 17 is a diagonal top view of a self-regulating wind amplifier and brake system showing the high wind capture ladle and wind amplifier & brake blades position at wind speeds of 70 to 200 mph.

FIGS. 18, 19, 20 and 21 are top views of a self-regulating wind amplifier and brake system with turbine/amplifier top plate removed for internal view showing the regulator ladle arm position at four different wind directions.

FIG. 22 is a top view of a self-regulating wind amplifier and brake system with turbine/amplifier top plate removed for internal view showing the direction and path of wind through and around the self-regulating wind amplifier and brake system at 30 mph wind speeds with safe generator rpms.

FIG. 23 is a top view of a self-regulating wind amplifier and brake system with turbine/amplifier top plate removed for internal view showing the direction and path of wind around the closed self-regulating wind amplifier and Brake System at 70 or greater mph wind speeds with no turbine rotation.

FIG. 24 is a diagonal top view of a column with a single self-regulating wind amplifier and brake system mounted on top of a single base section.

FIG. 25 is a diagonal top view of the internal frame and generator of a column with a single self-regulating wind amplifier and brake system mounted on top of a single base section.

FIG. 26 is a diagonal top view of a column with a single self-regulating wind amplifier and brake system mounted on top of multiple base sections.

FIG. 27 is a diagonal top view of a self-regulating wind amplifier and brake system showing a modular configuration or multiple turbines stacked vertically with linked brake/amplifier blades in the open louver position on top of a single base section.

FIG. 28 is a diagonal top view of a self-regulating wind amplifier and brake system showing a modular configuration or multiple turbines stacked vertically with linked brake/amplifier blades in the closed louver position.

FIG. 29 is a diagonal top view of a self-regulating wind amplifier and brake system stacked on top and linked to two additional brake turbine modules, with blades and blade rods removed to show the blade linkage plates and internal turbines.

FIG. 30 is a diagonal top view of a self-regulating wind amplifier and brake system showing a modular configuration or multiple turbines stacked vertically with the amplifier louvers and internal frame removed.

FIG. 31 is a front view showing the internal frame of the self-regulating wind amplifier and brake system and column base, with the generator and generator shaft visible to show that the amplifier and brake assembly's amplifier & brake shaft is separate and independent of the turbine generator shaft.

FIG. 32 is a front view of a self-regulating wind amplifier and brake system showing a modular configuration or multiple turbines stacked in line with the amplifier louvers and internal frame removed to show that the amplifier and brake assembly's amplifier & brake shaft is separate and independent of the turbine generator shaft.

FIG. 33 is a front view of a self-regulating wind amplifier and brake system with all but two blades and blade rods removed to show the space between the brake shaft and the generator shafts isolating the generator from the braking system. The view also shows the decretive profile of an optional wind vein attached to one side of the wind capture ladle.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

It is to be understood that all discussion of specific wind speeds, amount of force and/or turbine speed are disclosed as examples in relation to depicted embodiments. Other embodiment so the disclosed system may have other limitations or chosen operating parameters. No limitation to the specific operating parameters is intended or should be inferred.

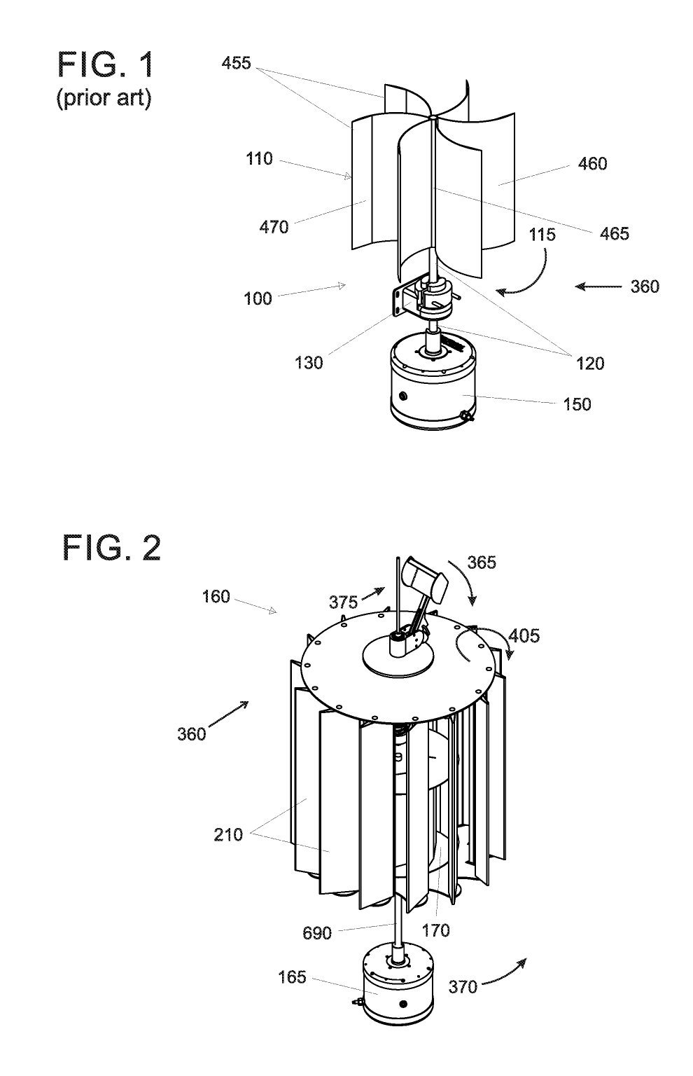

Turning first to FIG. 1, a typical prior art vertical shaft wind turbine generator and brake system 100 is shown. Typical vertical turbine generator and brake systems 100 includes a typical vertical turbine 110 with blades 455 attached around an axial generator shaft 120 that is connected to and rotates a generator at the other end of the shaft, and has a stationary shaft brake 130 attached around the generator shaft 120 that when activated will clamp down around the shaft with force to stop the rotation of the shaft. Incoming wind 360 impacts the blades 455 in a number of ways. First, the wind may be shed, meaning that it passes around blades 455 of turbine 110. Second, the wind may be captured between blades 455. Blades 455 include capture surfaces 470. Captured wind may have a positive impact, turning typical vertical turbine 110 and the generator powered by typical vertical turbine 110. Captured wind may also have a negative impact, trying to turn blades 455 in the opposite direction and thereby impacting output to the generator powered by typical wind turbine 110.

Finally, the wind may have a neutral impact, meaning the wind is not captured by blades 455. Blades 455 also include neutral surfaces 465. The design is such that the force of the wind contacts capture surfaces 470, thereby creating positive impact on the capture surfaces 470 while also allowing the negative force to pass around the other side of typical vertical turbine 110, or through and around shed surfaces 460, thereby creating negative impact on the shed surfaces 460. Further, positive impact to capture surfaces 470 is the directed near generator shaft 120 in the center of the turbine 110, which reduces the impact point to the axis between capture surfaces 470 and center of the turbine 110 at the generator shaft 120, producing very little leverage. Thus, only a fraction of the wind's potential is converted to energy or torque. Typically blades 455 meet the incoming wind and gently curve its direction inward flowing freely inward and toward the center axis or the axial generator shaft 120 producing very little torque.

Negative impact pushes shed surfaces 460 in the opposite direction desired, which fights against positive impact to the capture surfaces 470 and desired rotational direction diminishing the speed and torque potential of typical vertical turbine 110 as a whole, which creates a pulsing affect in the rotational speed and energy production levels. Typical VAWTs create positive and negative forces that are momentarily equal in exposure at best but while rotating move into positions around the axis that create more negative impact on the shed surfaces 460 than positive impact on the capture surfaces 470, and when transitioning from the equal exposure to the greater negative exposure the pulsing affect is realized as the blades 455 on each side of rotation axis fight against each other to turn typical vertical turbine 110 in two different directions. The exposure of capture surfaces 470 is increased by the shape of blades 455, which capture more wind than is deflected, and shed surfaces 460 deflect more air than they capture, therefore typical vertical turbine 110 is forced to turn is the positive direction. However, as long as shed surfaces 460 create momentary or constant capture surfaces in the shed position, an ever-present choking or braking affect is created that reduces the potential of positive forces and directional rotation, limiting the production of power from typical vertical turbine 110. The transition to more and then less and then more negative forces creates the fast and slow pulsing action and generator shaft 120 of typical vertical turbine 110 even in a constant wind speed, creating an undesirable wavelength of power.

As illustrated in FIG. 1, the shaft brake 130 has a plate or method of securing it to a support frame making it stationary and not able to rotate with the generator shaft 120 at any time. When winds speeds are too high for safe rotation of the generator 150 the shaft brake 120 is activated and its clamping calipers are tightened around the generator shaft 120 abruptly stopping it rotation. This abrupt end to rotation of the generator shaft does then protect the generator 150 from the potential of over rotation and damage, but in contrast creates a tremendous amount centrifugal force by the turbine 120 still trying to freely spin in the normal direction of rotation 115. This rotational inertia force is then directed to the turbine's 110 attachment point to the generator shaft 120, which at that point is a destruction collision of molecules between the materials each are composed of. This eventually, if not immediately, results in damage to the connection point between the turbine 110 and the generator shaft 120, and/or both the turbine's 170 blades 455 and the generator shaft 120. Typically, the either or both the turbine 110 or the generator shaft 120 are sacrificed to save the generator 150 and the power grid or batteries system it is connected to.

FIG. 2 depicts a self-regulating brake and amplifier system 160 around a wind turbine 170 according to the present disclosure. The self-regulating brake and amplifier system 160 covers turbine 170 and then dictates where and how much of the force of the wind will contact the surfaces of the turbine 170 blades surfaces. The blades 210 of the brake/regulator/amplifier system 160 are positions around the turbine 170, each angled in such a manner as to direct more air into the capture surfaces of turbine 170 than would normally if the turbine 170 was out in the open by itself. This amplifies the internal winds speed, increasing the force applied to the capture surfaces of the turbine 170 and creating more torque to the generator shaft 690 producing more power production. At the same time other blades 210 are blocking the wind, reducing the amount of wind force that contacts the shedding surfaces of the turbine 170, and therefore reducing or eliminating any negative impact forces that would work to rotate the turbine 170 in the opposite direction of the normal direction of rotation 370. This further amplifies the positive impact of the wind directed into the capture surfaces of the turbine 170 adding more power production at the lower outside wind speed.

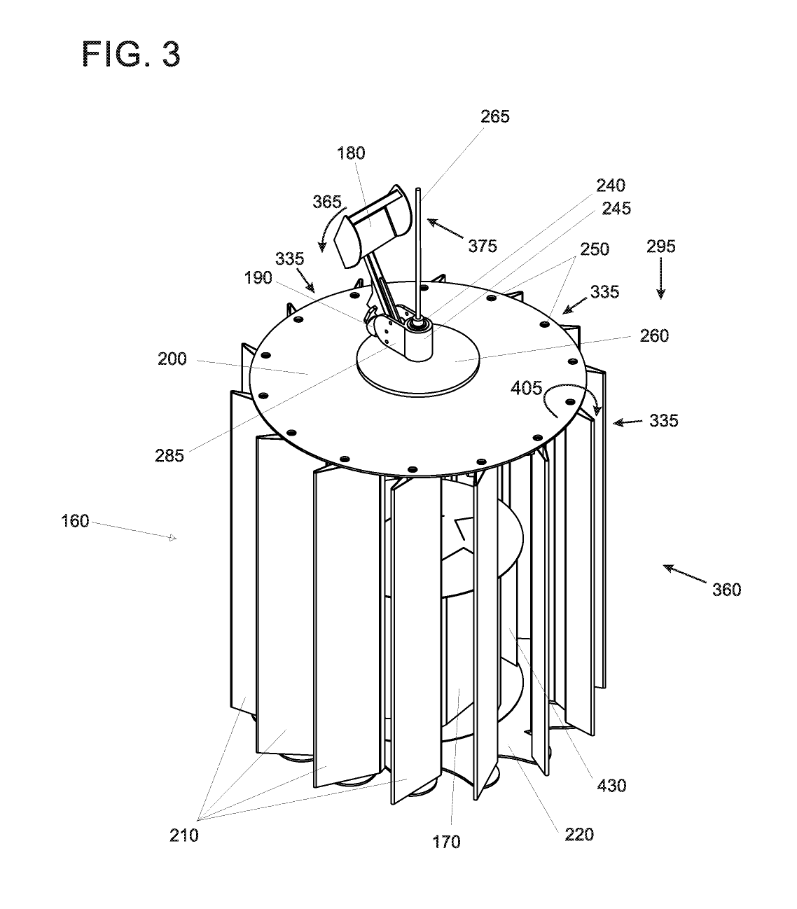

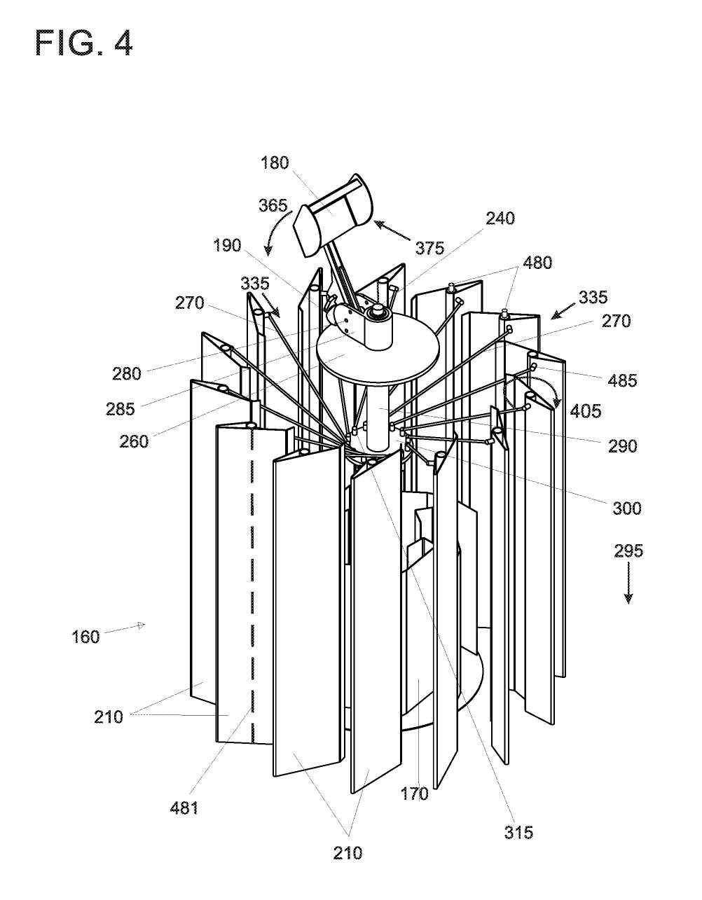

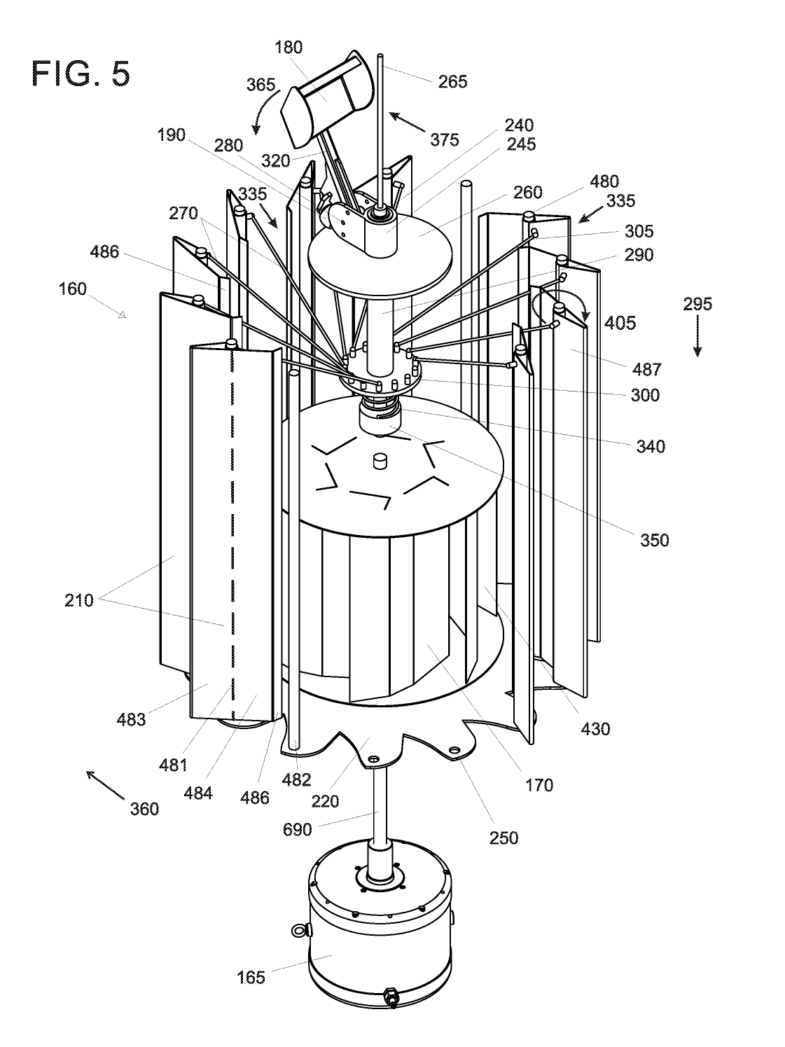

FIG. 3 shows all the externally visible parts of the self-regulating brake and amplifier system 160. FIG. 4 then shows the same angle of view but with the turbine amplifier brake top plate 200 removed to make internal parts visible. FIG. 5 is a front view of the system 160 allow more internal parts to be visible through the brake and amplifier blades 210. Referencing FIGS. 3 through 5, at the top of the system 160 is the high wind capture ladle 180 that captures incoming wind 360 moving in the direction of arrow 375 and which activates the brake/regulator and amplifier system 160 in real-time or near real time. It functions without the need of electricity or external power or manual controls etc. It functions purely by the force of the wind and impendent of everything else.

The system 160 reacts very rapidly and continuously to the changing wind speeds and direction. During safe wind speeds the amplifier blades 210 will be open and increase the amount of wind speed and force that will enter into the regulating system 160 and impact the blades 430 of the turbine 170. When the wind speeds are too high and would normally produce rpms greater than the generator's 165 maximum of 230 rpm rating, the regulating system 160 will restrict the amount of wind allowed to enter into the system 160 through its blades 210. The blades 210 function as either amplifier or braking blades depending on the winds speeds and the blades 210 respective position pivoting around each of the blade pivot points 480. The blades 210 are mounted on the center longitudinal axis 481. Each blade has a first half 483 on one side of the longitudinal center axis line 481, and a second half 484 on the adjacent side of the axis line 481. In the depicted embodiment, the pivot points 480 are each end of a rod 482 that runs the length of the longitudinal axis, seen in FIG. 5. One skilled in the art will realize that other design would work as well. The plate forming the blade folds over at the edge of the first half of the blade 483 and continues on the underside of the blade 215 to the rod 482 forming wing 487. The fold over and wing provide a smooth surface over the blades pivot tube for the air flowing past the blades 210, into the chamber

Pivoting the blades from the center axis helps insure the resistant pressure on the blades balances on both sides regardless to the position, requiring the least amount of force to rotate them against the wind. The first half of the blade 483 that opens outward against and into the wind has X force trying to keep the blade from rotating open. The other half of the blade 484 is actually assisted by the wind force trying to push and rotate the blade to the open position. This creates a neutral location for the pivot axis line and requires less leverage force on the ladle arm to close the blades, meaning less wind force is required to be captured and converted to downward force on the ladle arm.

FIG. 3 also shows fixed to the top of the brake shaft 240 is a lightning rod 230. Because of the design of the system 160 this can be done with no threat to the generator 165 as the brake shaft 240 is not connected to the generator shaft 690. Any current produced by a lightning strike to the lightening rod will be directed through the stationary brake shaft 240 and then into the internal frame of the system 160 and down into the ground via grounding rods. If the system is elevated on top of a column base 390 the current would run thorough the system 160 internal frame and then into the internal frame of the column base 390 and to the grounding rods.

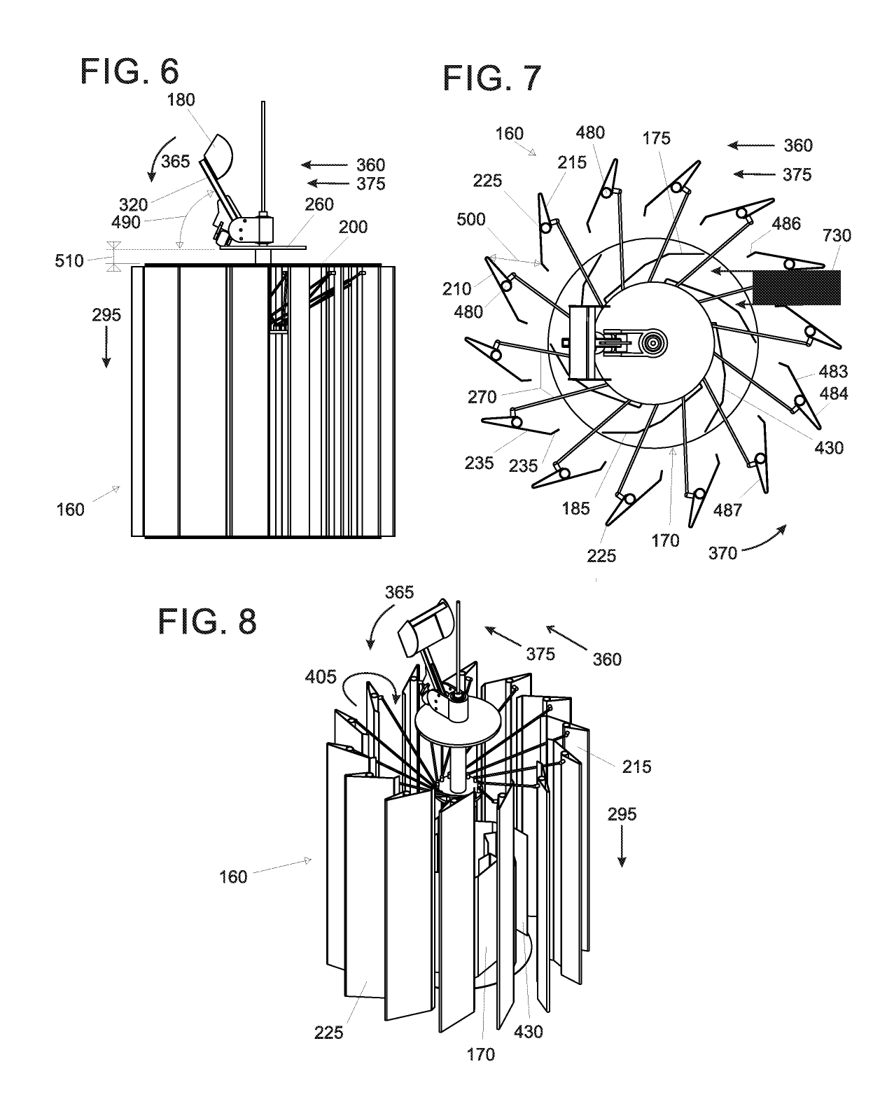

FIGS. 6 through 23 illustrate a braking system 160 scaled in size for a generator 165 that has a maximum of 230 rpm rating. If 230 rpms are exceeded the generator will be over-rotating and can be damaged or explode from voltages production greater than its capacity to contain and/or push into the power grid and/or batteries, it is supplying power. Therefore, the generator 165 along with the turbine 170 and the generator shaft 690 in FIGS. 6 through 23 must not be allowed to exceed 230 rpms.

FIGS. 6, 7 and 8 illustrates the angle 490 of the ladle arm 320 in relationship to the pressure plate 260 with wind speeds from 0 up to but not to exceed 40 mph, along with other relative geometry at those wind speeds. Incoming wind (arrow 375) is captured in the bowl shaped reservoir of capture ladle 180 and downward pressure in the direction of arrow 365 is applied to the ladle arm 320 as a result.

The ladle 180 can be made of different shapes. If it is flat, it becomes a paddle plate instead of a cup, and it has to have much more surface area to convert x wind speed into the force needed to overcome a spring with an initial resistant force of Y. By putting a cup on the end of the ladle/leverage arm the size of the cup required to convert x wind speed to overcome the spring force of Y is much smaller in width/height and length. The cup also provides two or more surfaces that will insure an increase of wind applied force as the arm is pushed downward and the angle of the cup impact surfaces change in relationship to the horizontal direction of the wind. A single surface such as a wing or paddle will move downward to an angle that would then deflect the wind and not be able to convert it to an increasing applied force that would continue to move the ladle and arm downward, and would begin to flap up and down as it is forced to downward with converted force and released to go back up when the wind is deflected and then back down when the paddle moves up high enough to convert the force again, and repeat this action in frequency until the wind decreases enough to fail to push the paddle down to the deflecting angle. Hence a single surface wing or paddle will ultimately fail in function when the wind speed is too high. The two or more surfaces of the ladle insure the adequate surface area(s) are always impacted by the wind at such an angle that the wind force is converted into downward force to the ladle and lever arm regardless to how high the winds get. The three surfaces as illustrated are designed to capture and convert the required force to close the system at unsafe wind speeds, but to not capture too much wind, creating unnecessary force on the systems frame and parts.

As long as the wind speed remains below 40 mph the system 160 will remain static and the amplifier blades 210 will be in the open position as seen clearly in the top view of FIG. 7. Line 500 is a given distance between the blades 210 of the brake is while in the fully open position. This directs and allows the optimal amount of wind to enter into the system 160, and deflects any wind that would otherwise produce shedding forces on the blades 430 of the turbine 170. This optimal amount of wind is the amount of wind that will not over rotate the generator 165. This amount of wind is shown schematically by block 730. Block 730 is not intended to show the specific path of the air flow, rather the relative amount of air as compared to later drawings as the blades close as described below. Note the angle 490 in FIG. 6 at 0 to 40 mph wind speeds and the dimension 510 that is the distance between the pressure plate 260 and the top plate 200.

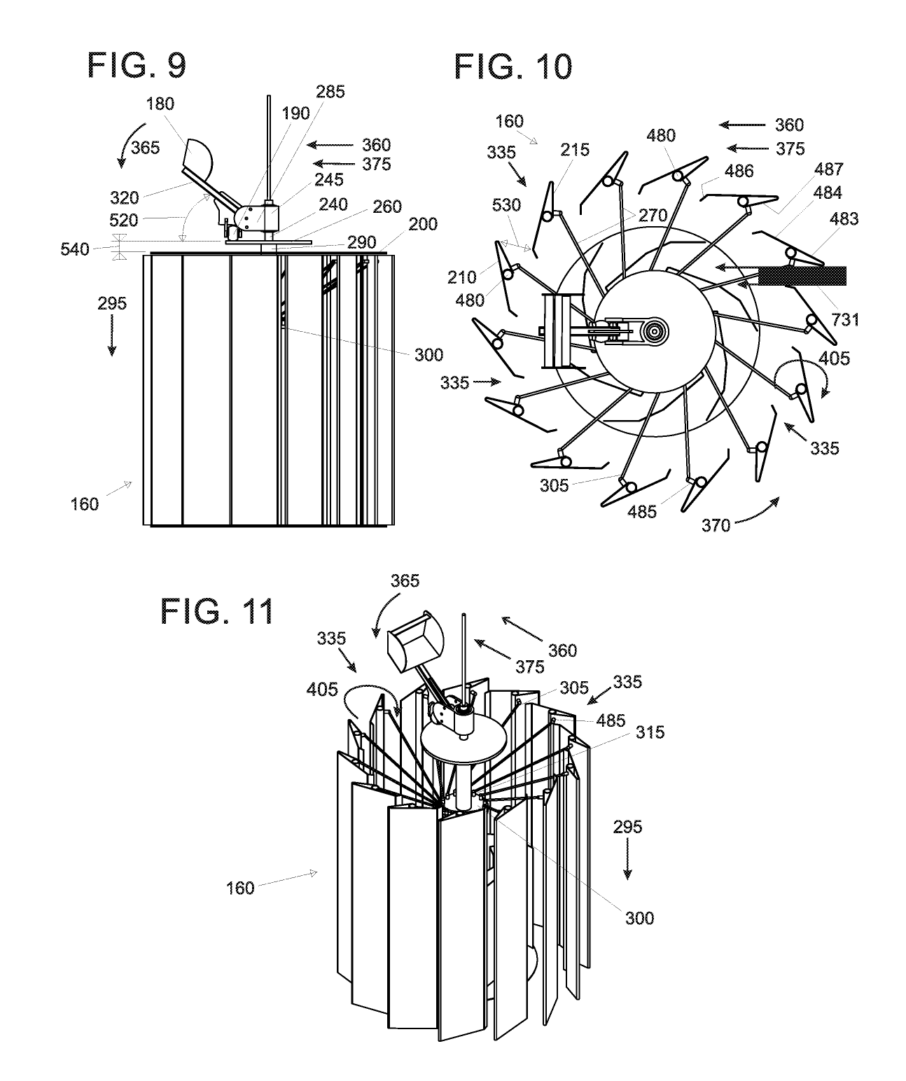

In FIGS. 9 through 11 the wind speed increases to 50 mph that are in excess of that determined to be safe for the generator's maximum capacity of 230 rpms of the depicted embodiment. Above 40 mph the capture ladle 180 can no longer resist the force of the winds and begins to move downward as shown by arrow 365 until it reaches the position shown in FIG. 9 at about 50 miles per hour. As the capture ladle is forced downward and the angle 520 of the ladle arm 320 decreases in relationship to the high wind regulator pressure plate 260. As the angle decreases a pressure wheel 190 at the other end of the ladle arm 320 forces the high wind regulator pressure plate 260 downward sliding along the amplifier and brake shaft 240 as shown by arrow 295, decreasing distance 510 to distance 540. The bottom end of the ladle arm 320 pivots on a bracket 285 that is fixed to a bearing tube 245 which rotates around the brake shaft 240 as the wind changes direction automatically driven by the force of the wind 375. This allows the ladle arm 320 to stays in line with the incoming wind direction 360. The high wind pressure plate 260 is fixed to the top end of pressure plate drive tube 290. The drive tube 290 slides over the brake shaft 240 and moves up and down as the pressure wheel 190 forces the pressure plate 260 downward as shown by arrow 295. Fixed to the bottom of the drive tube 290 is the control arm plate 300 and when the pressure plate 260 is force downward the control arm plate 300 is forced down with it equally. Directly under the control arm plate 300 is a calibrated compression spring 340 that is around the brake shaft 240 and holds up the weight of control arm plate 300 with no wind speed and additional forces up to a predetermined wind speed. A single or multiplicity of pneumatic or hydraulic cylinder(s) equally calibrated could be used with or to replace the spring(s) to produce the same function.

The spring 340 quickly responds to varying wind speeds above 40 mph with a calibrated resistant force controlling the downward movement of the control arm plate 300. The control arm plate 300 is connected at its blade end 305 to one of a series of blade control arms 270 that is connected to one or a number of the control blades 210, moving them in unison with each other and therefore controlling the opening distances between the blades 210. As the control arm plate 300 is moved downward, it pulls the attached control arms 270 with it as shown by arrow 295. The other control plate end 315 of each of the control arms 270 are attached at a location on the underside of the first side 483 of the blades 210, off center from the longitudinal axis 481 on wing 487. As the control arms 270 are pulled downward with the control arm plate 300 they pull the attachment point 485 of the blades 210 inward toward the center of the system 160 as shown by arrow 335. By pulling one side of the blade 210 around the blade pivot point 480 it pushed the out face plane 225 of the blade 210 outward and towards the next blade's inner face plane 215 as shown by dimension 530 rotation 405 around 480. This results in the width of the airflow being reduced, as is shown schematically by block 731 in FIG. 10. Note that since the airflow is now at a higher speed (50 miles an hour or more) the actual force impacting the turbine blades has not be reduced appreciably at this point, as the volume of wind that is permitted to impact and be converted to torque by the turbine blade has been reduced to equal the torque produced by the larger volume of wind at a low speed by the regulated opening of the system. A hand lever at ground level can be incorporated in place of or in tandem with the capture ladle 180 to adjust the up and down position of the pressure plate, which can manually adjust the opening dimension between the blades 210 independent of the wind speeds. This lever could be operated electronically monitoring wind speeds and mechanically adjusting its position. However, the system works independent of any such lever of the like.

The distance the pressure wheel 190 is positioned away from the brake shaft 240 also relates to the size of the cup and spring force used with it. It seems to be preferred to keep things small and light if possible to produce the mechanical action without failure. The wheel can be placed at any distance to work mechanically, just needs to match all the components accordingly for the desire result for the given wind speed.

As wind speed increases over 1 mph the spring 340 maintains resistant upward force to the bottom of the control arm plate 300 and as long as wind speeds are 40 mph in the depicted embodiment or less the spring 340 hold the control arm plate 300 in a static position on the brake shaft 240. The brake shaft 240 is fixed static to the internal frame of the system 160 preventing it from move up or down. On the brake shaft 240 just below the spring 340 is fixed a spring support stop collar 350 that does not permit the spring to move any further down the brake shaft 240. At 50 mph wind speed, the downward force the ladle arm 320 is placing on the pressure plate 260, and therefore the control arm plate 300 below it, has overcome the resistant force of the spring 340 and has shortened the springs length between the control arm plate 300 and the stop collar 350 to the position shown in FIG. 9. The resistant force of the spring 340 is calibrated in the depicted embodiment to only allow the control arm plate 300 to move downward only so far limiting to the distance 540, and the angle 520 of the ladle arm 320 is directly related and also limited to it position shown. At 50 mph wind speed the dimension 530 is now considerable less than dimension than dimension 490 in FIG. 6 at 0-40 mph. With the decreased dimension 530 the amount of wind is regulated by the movement of the blades 210 in the direction show by arrow 405 FIG. 10. This results in a reduction of the force of the wind inside the break to an amount wind not to exceed the equivalent of 40 mph, and will maintain the internal force striking the turbine blades at or near a constant and safe optimal generator rpm of 230 so long as the wind speed outside is between 40 and 50 mph.

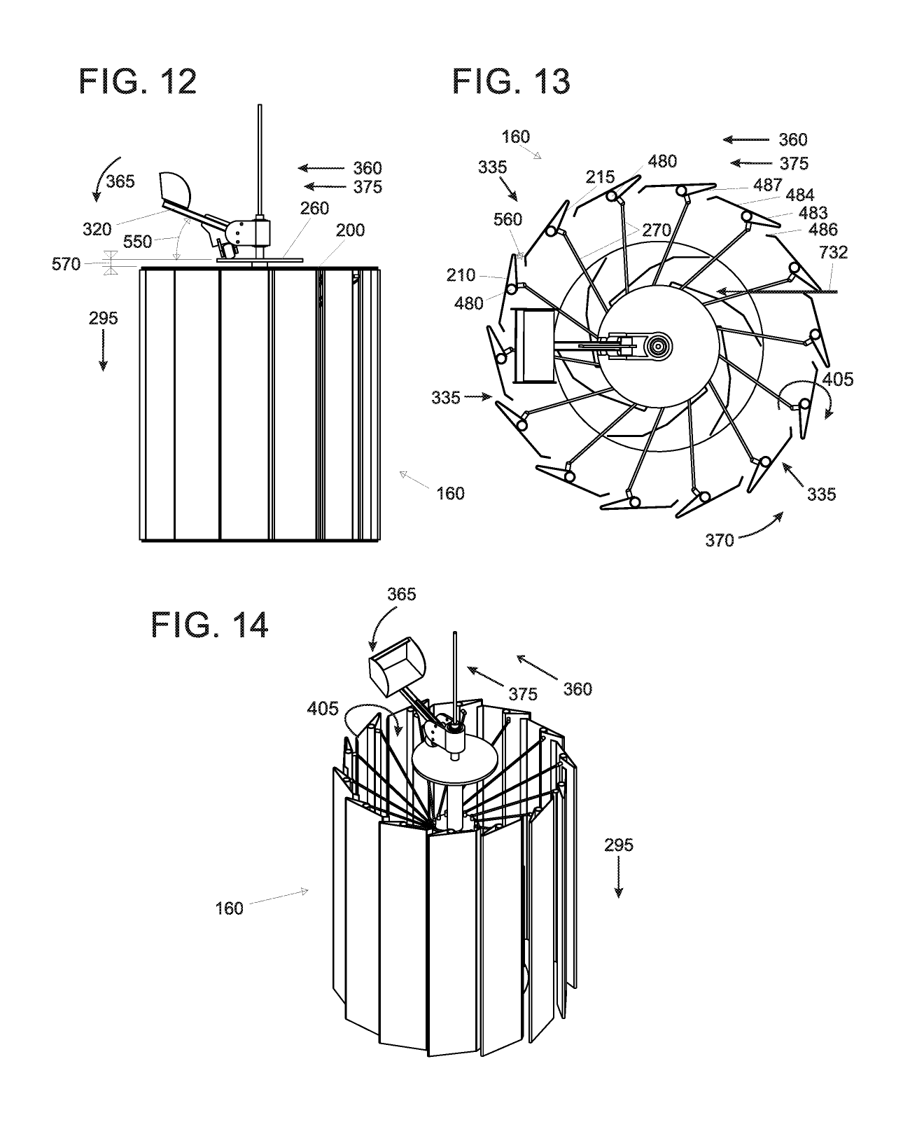

FIGS. 12 through 14 show the opening 560 between the blades 210 decreased more as the wind is now at 65 mph. Because the regulating systems has automatically adjusted for the increased external wind speed it rapidly minimized the amount of wind allowed to enter into the system maintaining an internal wind force of the equivalent of external wind speed of 40 mph and at or near the optimal generator 's 230 rpm for maximum safe energy productions. Because of the added force of the wind at 65 mph it is apparent the angle 550 of the ladle arm 320 has decreased measurably from its dimension 520 at 50 mph wind speed. The airflow into the turbine is depicted schematically by block 732 in FIG. 13.

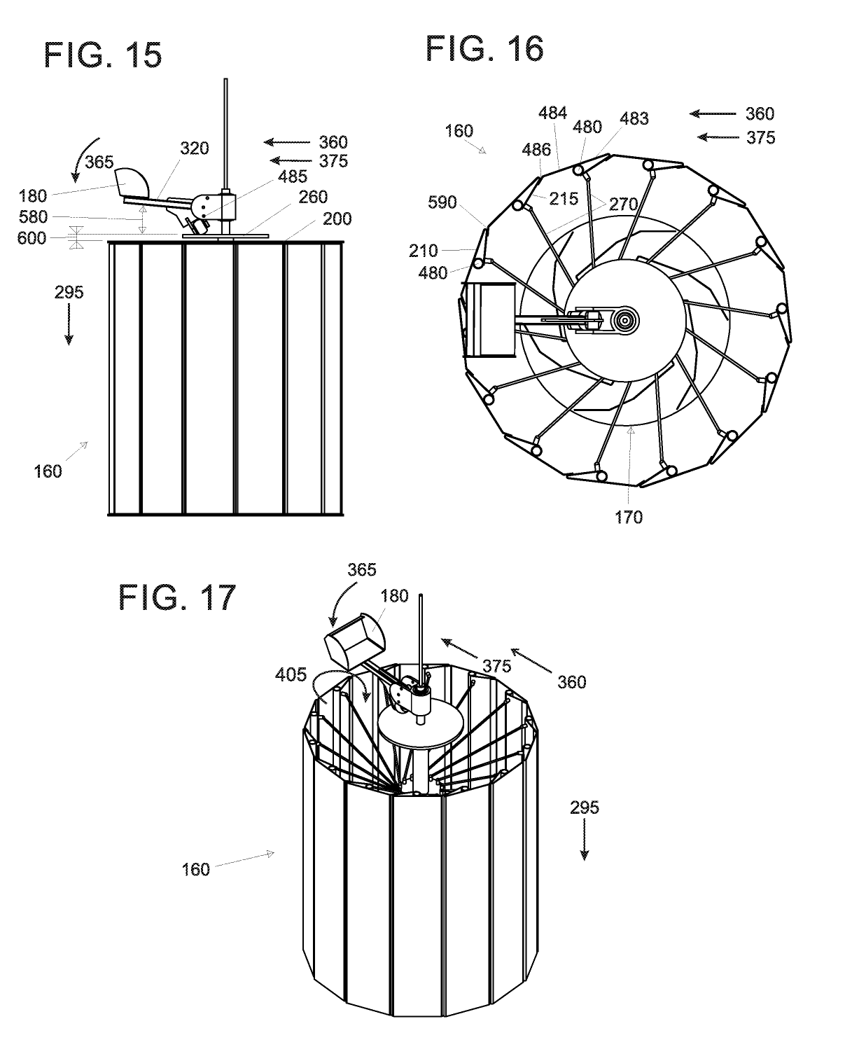

FIGS. 15 through 17 show the system 160 closed as a result of wind speeds of 70 or higher in the depicted embodiment. The spring 340 is calibrated as such not to be able to resist the applied forces of 70 or more mph wind impacting the capture ladle 180 and allows the ladle arm 320 to be forced down to its lowest position angle 380 and it stopped by the ladle arm stop pin 485. The stop pin 485 will not allow the blades 210 to over rotate and open in the opposite direction, and effectively with the downward force of the wind on the capture ladle 180 locks the blades 210 in the brake or closed position. As can be seen in FIG. 16, the second half of blade 484 has a small angled section 486 that overlaps with the first section 483 of the blade adjacent to it at the wing 487. The overlap serves to stop the wind from entering into the turbine chamber with any force, and the overlap reduces or eliminates the peeling force that would work to open the blades in the closed position. The wing 487 serves as both a stop for the adjacent blade, and a surface seal. With a minimum amount of surface contact made between blades, the wind is directed to go past the adjoining seem rather than inspired to try to enter between the blades. This means that wind flowing past the seam has less resistance than entering the seam, so the air goes past and the pressure or force to pry open the blade reduced or eliminated. When completely closed there is little to no pressure to open the blades by the impacting winds that has to be resisted and more than equaled by the mechanical structure to hold them closed reducing wear on the system and allowing lighter structural parts. Note that if another generator is used that has a higher rpm capacity the ladle size and spring calibration can be adjusted accordingly. For example if the generator has a max capacity of 350 rpms and 30 percent more shaft resistance, the ladle can be smaller and the spring force calibrated to not respond until wind speeds exceed 75 mph and close the systems blades at 110 mph, or any optimal combination of minimum and maximum response wind speeds.

When closed the system 160 brakes all wind from entering the system 160 rapidly dropping all internal winds forces to zero for as long as 70 or more mph wind speeds are outside the system per this embodiment. This protects the generator 170 from over rotating at too high of rpms. When the system 160 closes to brake the wind, the turbine 170 begins to slow down in rotation as it no longer has any drive force to keep it rotating at its present speed. The turbine 170 continues to rotate at a descending speed strictly from its own centrifugal forces until it comes to a safe and slow stop. This method of braking or stopping the generator 165 rotation, eliminates any potential damage to the turbine 170, the generator shaft 690 and the generator 165.

The additional benefits of the system 160 being self-regulating driven by the real-time forces of the external wind speeds it acts as its own rapid brake release as soon as the external winds drop below 70 mph. When the wind drops from 70 to 69 mph the upward force of the spring 340 begins to push the control arm plate 300 upward slightly opening the distance between the blades 210 allowing air to begin to enter the system 160 once again creating internal wind speeds to drive the turbine 170. As the wind continues to drop the spring 340 forces the control plate upward with respect to the current external wind speed maintaining the optimal internal wind force to drive the turbine 170 at is optimal 230 rpms. If the wind speed drops to 50 mph and then suddenly increases back up to 65 mph with a gust of wind the system quickly reacts with the downward force of the wind to the control arm plate 300 adjusting the opening distance between the blades accordingly.

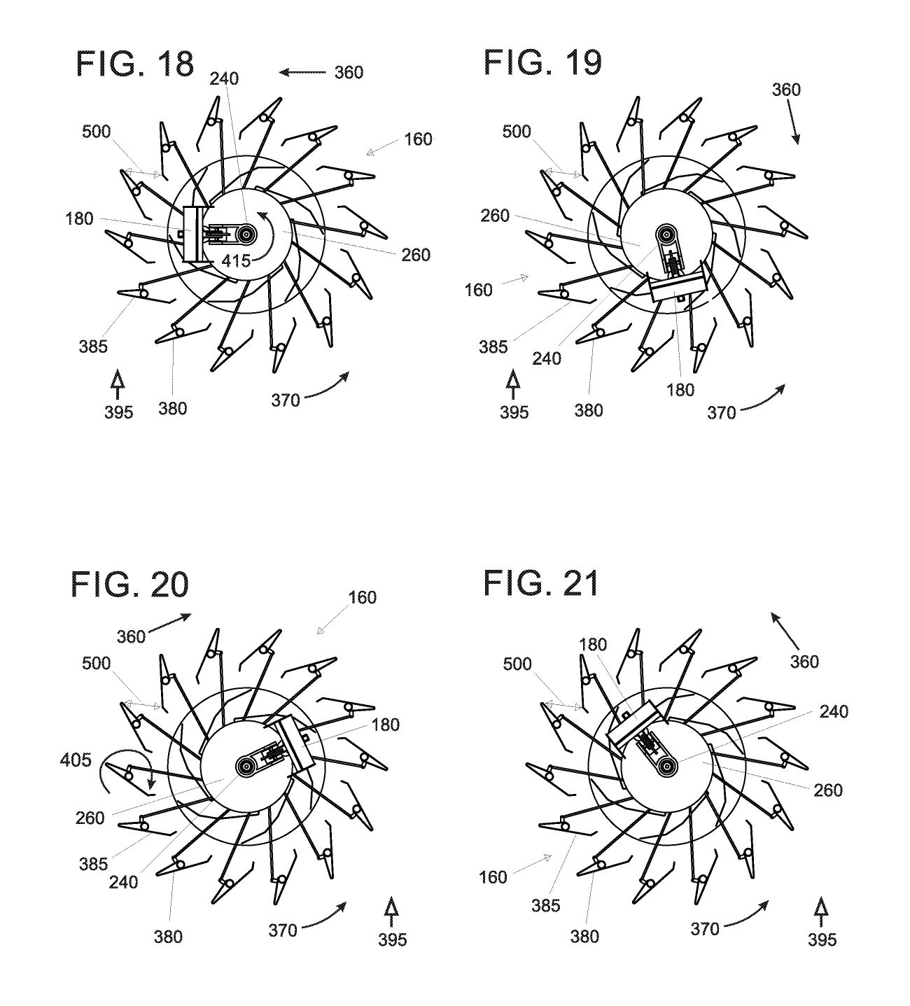

FIGS. 18 through 21 illustrate the system's 160 ability to equally respond to any changes in wind direction as the capture ladle 180 and ladle arm 320 rotate around the brake shaft 240. The capture ladle is positioned in relation to the center brake shaft 240 to where it functions behind the brake shaft 240 and so that it acts as it own rudder being directed to follow the direction of the incoming wind pivoting around the axis of the brake shaft 240 as shown by arrow 415. The regulating functions of the system 160 are not affected by the direction of the wind as it is designed to function independent of the radial position of the capture ladle 180. Regardless to where the pressure wheel 190 is positioned on the pressure plate 260, when the wind speed is sufficiently high enough to apply downward forces to the capture ladle 180 the pressure plate will be forced downward and internal wind speeds will be regulated by the position of the blades 210. If more finite response to wind direction is required a wind vane or wing 310 can be added to one of both sides of the capture ladle 180. The system 160 can maintain a nearly constant internal wind force regulation and any winds speed while wind changes direction function is not required to stop for the other to work. FIGS. 18 through 19 show four different wind directions and the position of the capture ladle 180 following and in line with the wind. It is also shown that regardless to any of the shown positions of the capture ladle 180 the locations of blade A 380 and blade 385 remain static in relation to the compass bearing North 395. Also it is shown that the position of the blades 210 and the opening space between the blades 500 remain the same, unaffected by the direction of the wind 360 and the radial position of the capture ladle 180 on top of the pressure plate 260.

This real-time self-regulating system 160 constantly adjusts to the ever changing external wind speeds maintaining for as long as possible the optimal internal wind speed and generator rpms for a non-pulsing high level production of energy, make vertical shaft turbine energy production more efficient and cost effective along with making it safer for all its components and ultimately its surrounding and population.

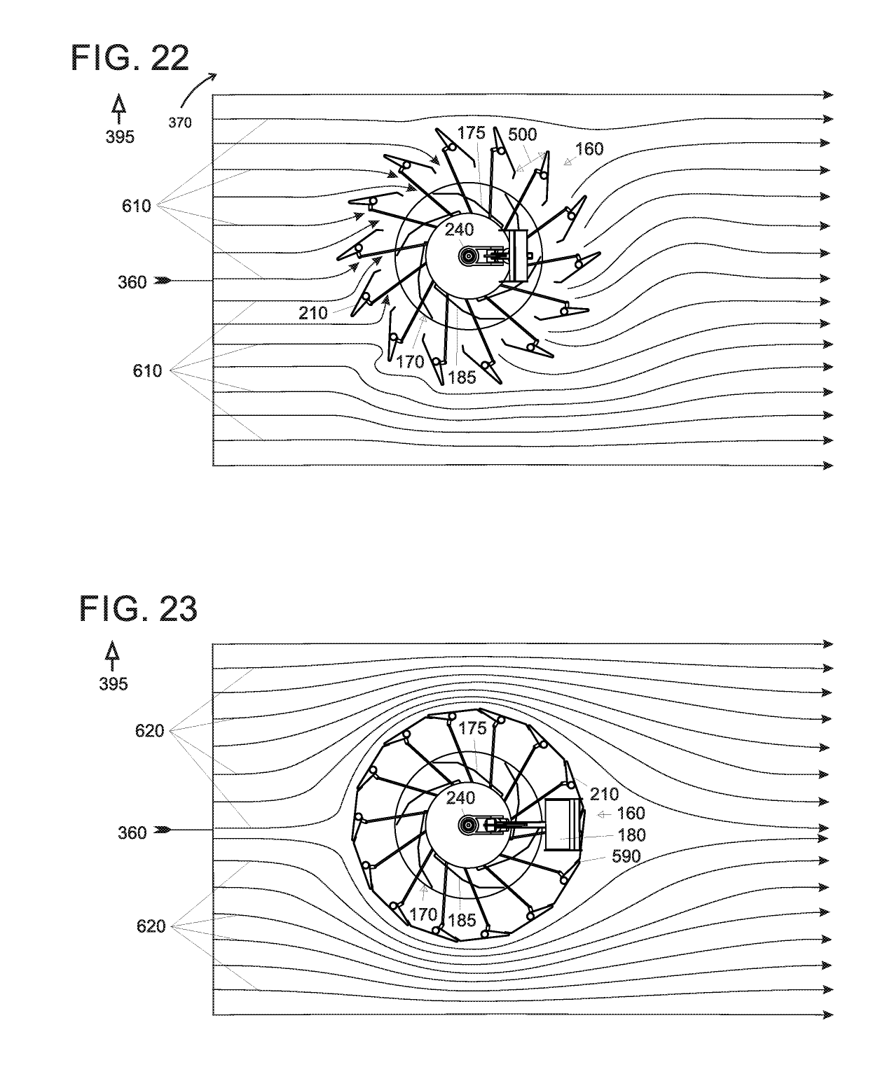

FIG. 22 is an aerial top view of the system 160 and illustrates the wind direction 360 and its path 610 around and through the system 160 at external wind speed of 30 mph. To the north 395 of the center of the brake shaft 240 al of the wind the impacts the system is directed into the system 160 where it is channeled toward the drive side 175 of the turbine 170. To the south of the center of the brake shaft 240 more than 70 percent of the impacting wind is also directed into the system 160 and channeled to the drive side 175 of the turbine 170, while the other 30 percent is directed around the south side of the system 160, allowing very little air currents to contact the shed side 185 of the turbine 170 with any noticeable force. Approximately 85 percent of the incoming air in front of the system 160 is captured by the blades 210 and directed only towards the drive side of the turbine 170. This eliminates and/or dramatically reduces all shedding forces and creates a smooth non-pulsing wave length of power production eliminating the need for power conditioning and stabilization hardware to be added to the electrical system used past the generator 165 electrical output connections. It is important to maintain equal opening dimensions 590 between all the blades because the wind that is captured through the front blades 210 is compressed through channeling and not to create drag forces within the air space of the system 160 there must be more volume of exhaust than intake. If intake and exhaust are equal a back pressure is produced inside the system and a resistant force similar to the shedding forces slow the rotation of the turbine 170 reducing energy production by as much as 45 percent of its potential. A small amount of wind turbulence is cause on the south side of the turbine by the blades 210 in their position, but that turbulent wind is forced to flow around and outside the system 160 with little to no effect on the internal flow of wind in the system 160.

FIG. 23 is an aerial top view of the system 160 experiencing 70 mph wind speeds or higher. The system is closed in the braking position not allowing any wind force to enter into the system and drive the turbine 170. The wind on both the north 395 and south side of the center of the brake shaft 240 is being directed around and outside of the system 160. The turbine 170 and generator 165 are safe from overturning and there is no threat of damage to them or the generator shaft 690 as they are not subject to any dynamic forces to stop their rotation, and they are free to operate the instant the threatening wind speeds 70 mph and above decrease to safe levels.

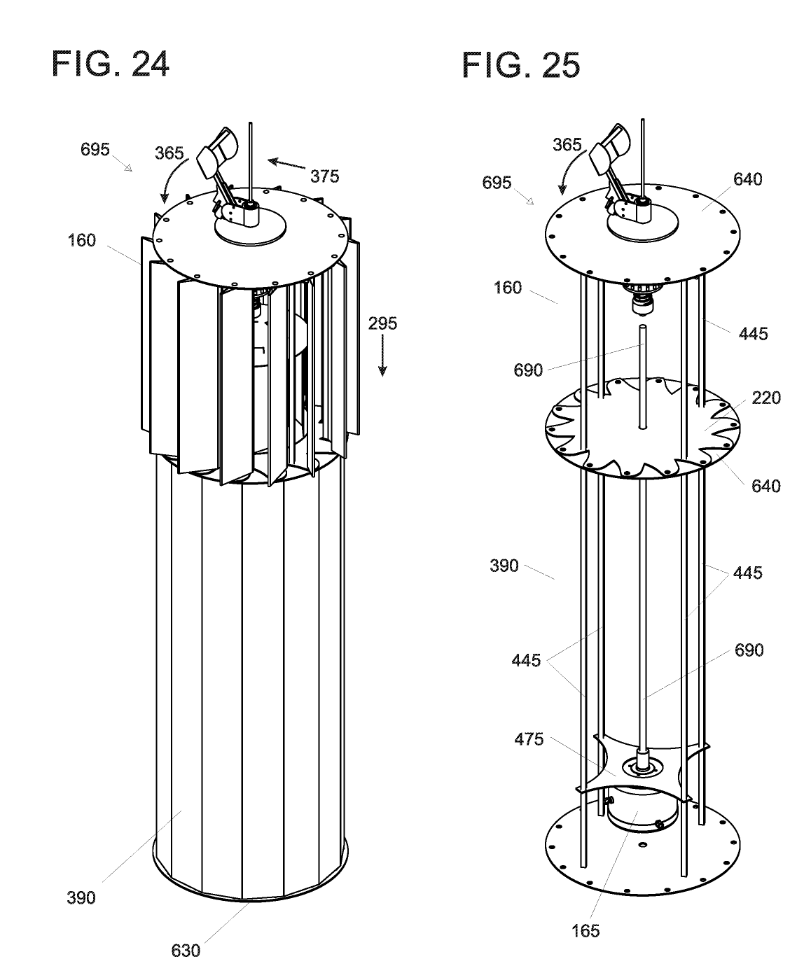

FIG. 24 shows the system 160 attached to the top of a column base 390 creating a completely integrated column 695 and close system of energy production. The column base 390 can be made any height dimension 650 as one piece, or of multiple sections stacked on top of each other.

FIG. 25 shows the internal frame of column 695 with all the blades 210 and 480 blade pivot rods and generator 170 removed. Inside at the bottom of the column base 390 is located the generator 165 with its generator shaft 690 extending upward inside of the column base 390. The generator is fixed in a static position to the internal frame 445 of the column base 390 allowing only the generator shaft 690 to rotate. The height of the column base 390 is dictated by its environment and surroundings. If there are no other objects or structures located within a given radius of the column 695 there is no need for the column to be very high off the ground. The total height is that required to contain and support the generator 165 and any linkage and electrical components required to the overall energy production system. If there are surrounding objects such as rocks, hills and trees and/or structures such as poles, fences, walls, vehicles, house, etc. it is ideal to have a column height 650 that is equal to or greater than 6 feet taller than the tallest object or structure around it to be able to capture any and all winds regardless to their direction. It may be elected to only go 6 feet higher than the objects or structure located to the north of the column 695 if that is the common direction wind comes from and ignore the heights of objects and structures to the south of the column 695. This being said any shift in winds then coming form the south will not product the energy potential of the system.

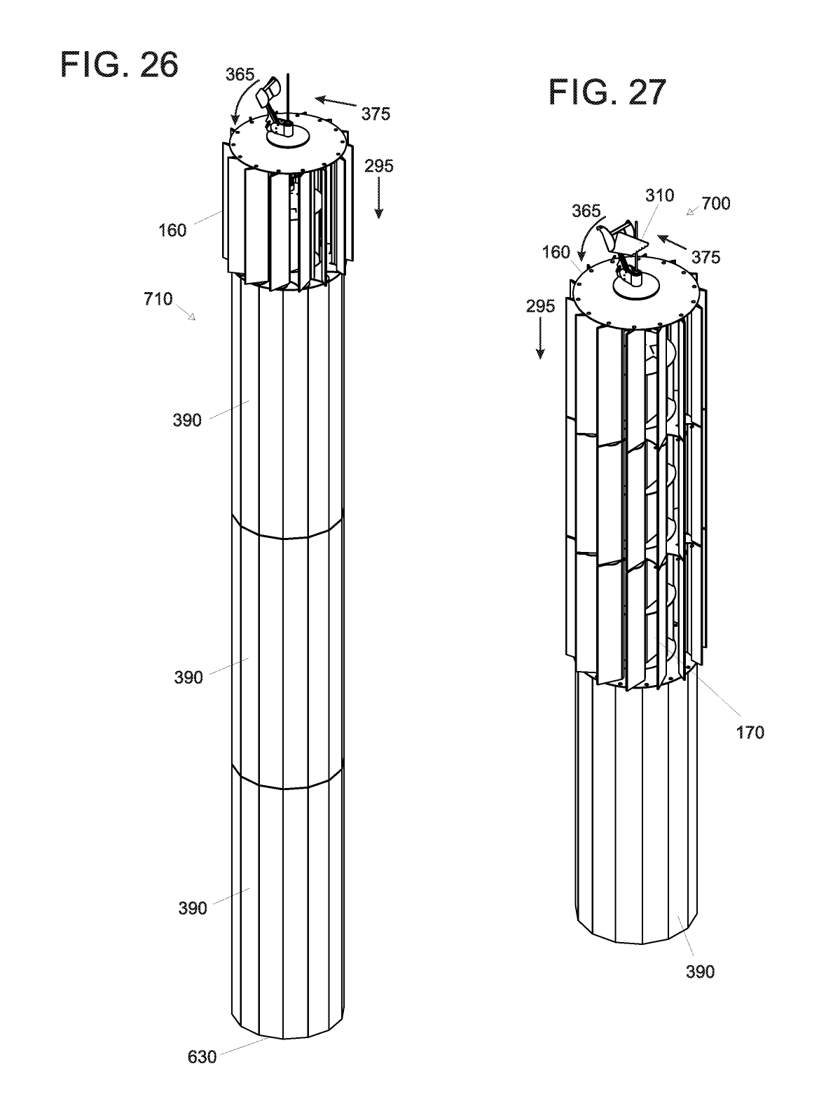

FIG. 26 shows a diagonal top view of a single system 160 mounted on top of multiple base section 390 extending the overall height of the column 710. The generator 165 is located near ground level in the bottom base section 390 for safe maintenance of the generator 165 not requiring a crane to lower it from the top, as would be the case in a typical vertical shaft turbine system. As many base sections 390 can be added to obtain the optimal height position for the system 160 within its surroundings to capture winds from all directions. The use of multiple base sections 390 allows you to increase or decrease the height of the column 710 at any time in the future without having to replace the single or multiple systems 160 at the top, making it more economical for any upgrades or changes required in the future.

FIG. 27 shows a diagonal top view of the system 160 with the two brake amplifier turbine modules 400 attached and link below it. They are set on top and attached to a column base 390 and collectively a turbine column 700. The system on top is shown experiencing 0-40 mph wind speeds and in the open state amplifying the entering winds to the drive side 175 of the turbine inside. The blades 210 of the system 160 are all linked to the blades 215 directly below it as is the blades 215 of the first module 400 are linked to the blades 215 directly below it, and so on if more modules 400 are desired. Inside the bottom of the column base 390 near the ground level 630 is where the generator 165 is located, with the generator shaft 690 extending upward from the generator 165 and connecting to the first turbine 170 in the lower module 400. From there the other turbines 170 in the two brake turbine modules and the system 160 on top are linked together by the extending generator shaft 690. They now all rotate as one with the exception of the generator that is fixed statically to the internal frame 445 of the column base 390. In the front view you can see the ladle arm angle 490 at the wind speeds of 0-40 mph, and the open position of all the blades 210 and 215.

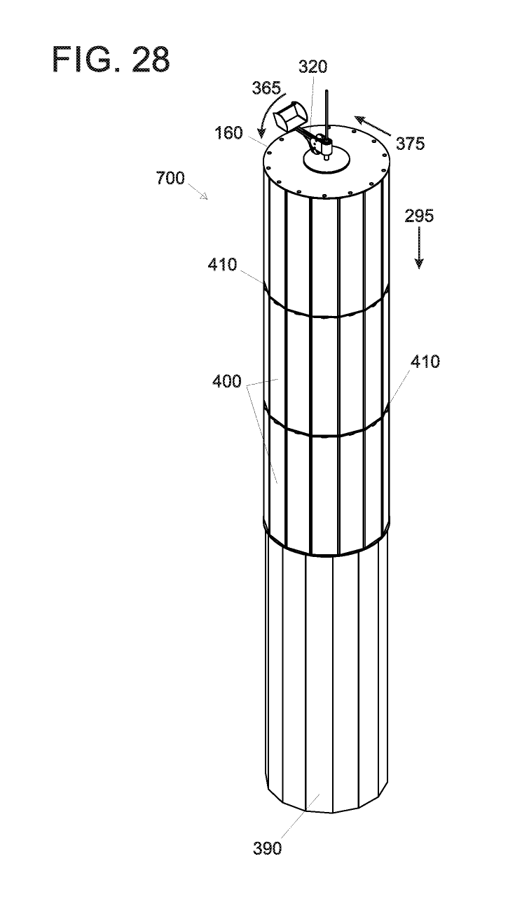

FIG. 28 shows a diagonal top view of the column 700 experiencing 70 or higher mph wind speeds. The system is in the braking state and has stopped all air from entering the system 160 and the below modules 400 eliminating any drive forces to the generator 165 in the bottom of the column base 390. The ladle arm 320 is in the locked position at the ladle arm angle 580. The entire column 700 has become a solid structure to the incoming winds allowing even wind flow around it with minimal outside forces created against its surfaces.

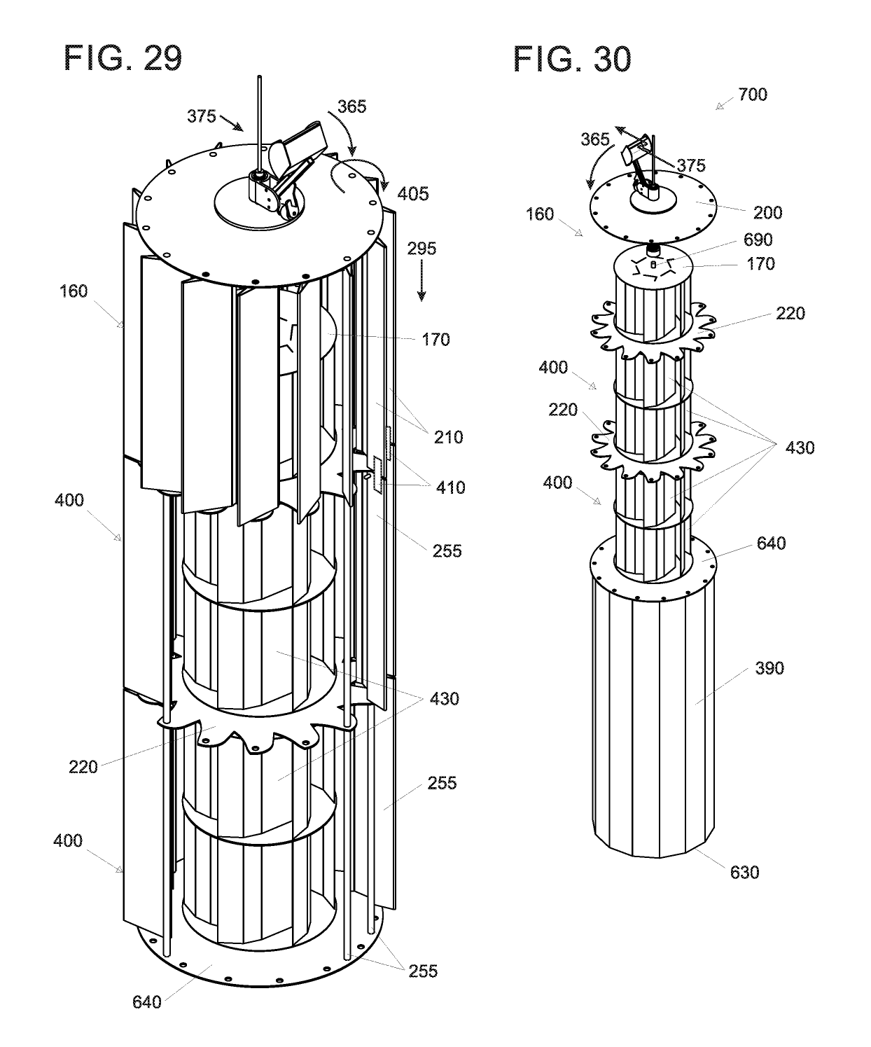

FIG. 29 is a diagonal top view of just the top section of the column 700 showing only the system 160 mounted on top of two brake turbine modules 400. The view has several blades 255 and blade pivot rods 480 removed showing the blades 210 and blades 255 linked together with a plate 410. You can also see how the blade pivot rod 480 are inline and running through the brake bottom plate 220 and the column top plate 640.

FIG. 30 is a diagonal top view of a column 700 with all the blades 210 and blades 215 removed for an internal view of the linked turbines 170 within the system 160 and the modules 400. By stacking turbines as shown, additional torque is created to the generator shaft 690. This is beneficial as generators have resistant force against rotation requiring a minimum level of torque to be produced by the turbine 170 to start turning it. The resistance it has against turning is one of is means to produce energy. The higher the resistant force the generator 165 has against rotating the generator shaft 690, the higher the level of power/energy is produce per single rotation and all rpms. This system 160 with its modules 400 allow a user to increase torque applied to the generator shaft 690 without increasing the foot print of the system at ground level 630 and the overall diameter of the column 700 at any level of height. It also permits the ability at some future date replace the existing generator 165 with a larger capacity generator. The column 700 can be extended upward with additional modules 400 until the desire torque required to rotate the new generator 690 is achieved. This eliminates the expense of replacing the entire wind energy system with a entirely new larger output system, or having to remain with a now inadequate system not producing enough energy to meet growing needs. This invention allows the additional turbines and regulating brake system modules to be linked together to create increased torque, with only the one original upper drive system to close the blades. The center pivot location of the blades always having a balanced level of forces both pushing to open and close the blades about its axis, regardless to the number of additional modules it does not require an increase in size or mechanism to drive the blades open or closed. A typical shaft brake system would have to be increased in size and capacity to overcome the increased torque produced by additional turbines requiring onsite modifications or system replacement. This inventions regulating and braking functions are independent of and not effected at all by the increase or decrease of torque to the shaft.

FIG. 30 also shows the stationary interface plates of all the sections making up the column 700. The column top plate that is attached to the column base's 390 internal frame 445 is the system 160 and/or module's 400 bottom plate 220. The modules 400 utilize the bottom plate 220 as its top plate. The top of the modules 400 top plates 220 attached to the bottom plate 220 of the above module's 400 bottom plate 220. The system's160 bottom plate 220 attaches to the column top plate 640 or the module 400 top plate 220.

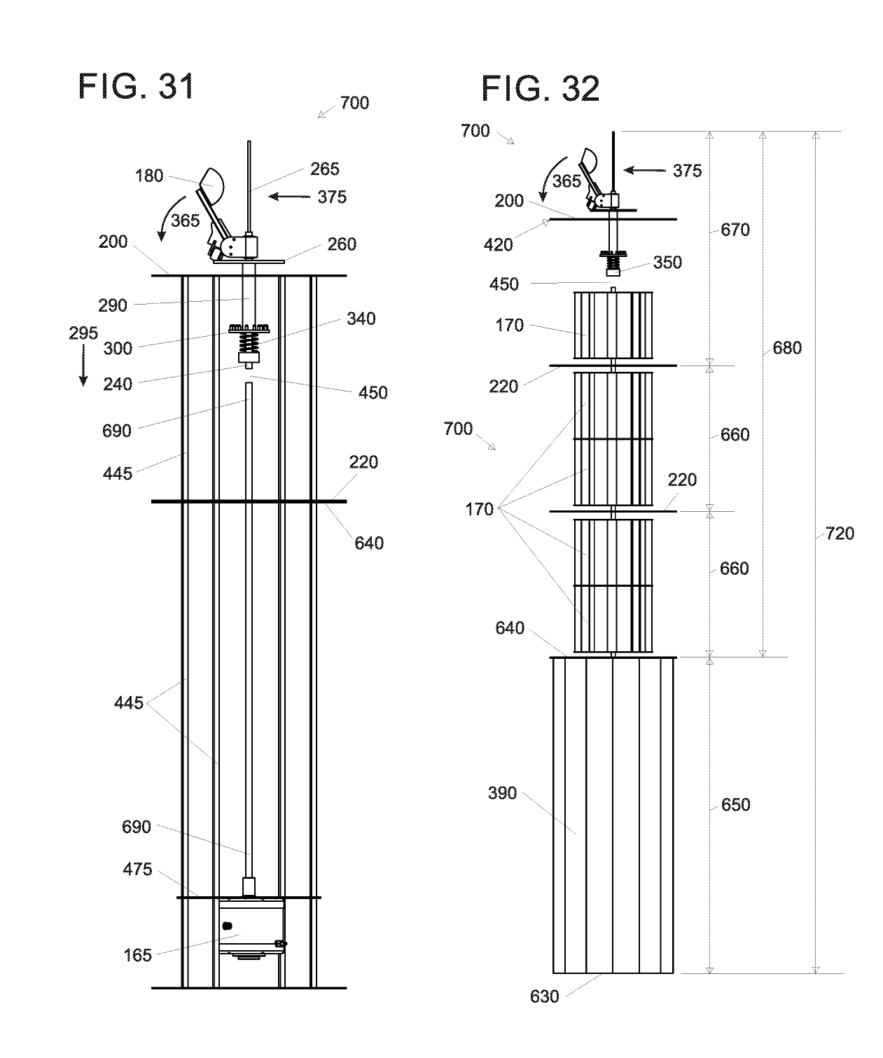

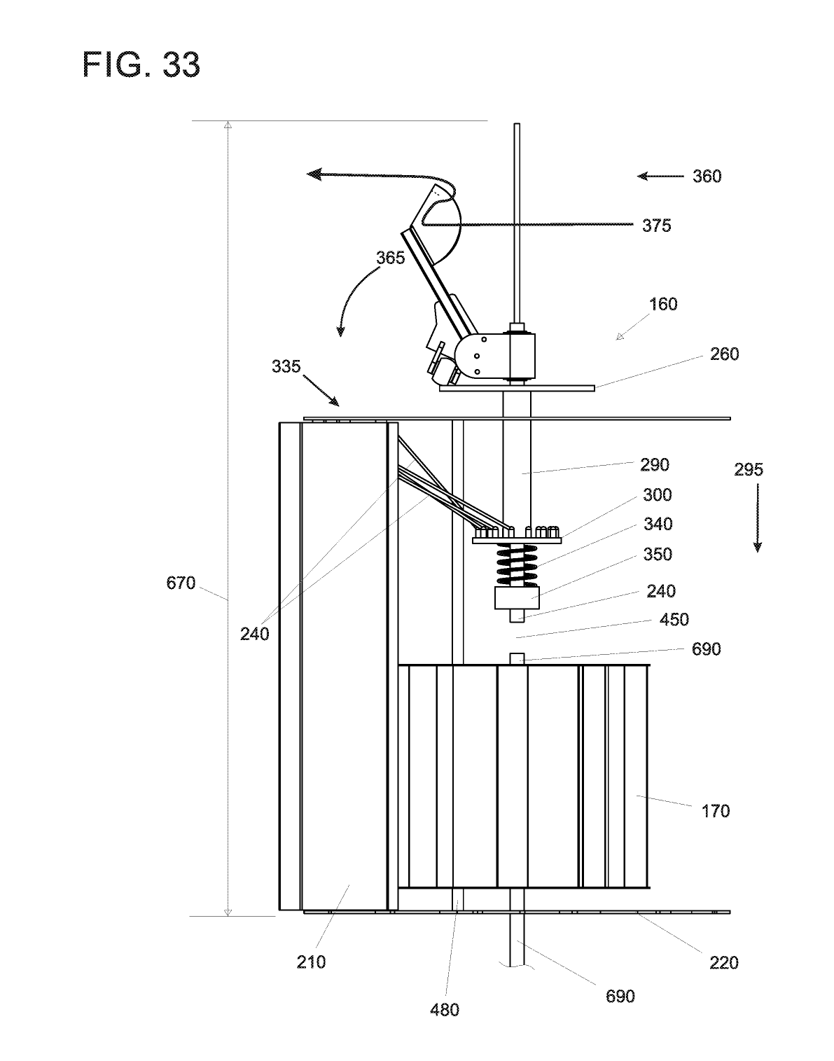

FIGS. 31 and 32 is a front view of a column 700 with all the system 160 blades 210 and the module 400 blades 215 removed to show and internal view. The column is showing internally that there is no connection or linkage of any kind between the system 160 brake shaft 240 and the generator shaft 690. They are intentionally independent of each other. Because the system 160 is designed to have its own shaft not connected with the generator shaft, in the unfortunate even of a lightning strike the lightening will be attracted to the top of the 160 system with a lightning rod 265 that is fixed to the top end of the brake shaft 240. The electrical current of the lightening hitting the lightening rod 265 will follow the path of least resistance. From the lightening rod 265 the electrical current will travel down the lightening rod 265 and then flow into the top of the brake shaft 240 to the top plate 200. Once the current hits the top plate 200 it will then travel to one of more down posts of the internal frame 445 and travel directly down to the ground dispersing into the earth via attached grounding wires and grounding rods. Because there is no connecting point between the brake shaft 240 and the generator shaft 690 the lightning strikes current will not travel to the generator, keeping it safe and not requiring replacement after a strike. The generator 165 is further isolated from the internal frame 445 by non-conductive anchors between the generator 165 and the generator mounting bracket 475 of the internal frame 445.

The brake shaft 240 remains static and does not rotate at any time. The generator shaft 690 rotates the direction 370 and the rotational torque produced by the turbine 170 is respective to the applicable wind speeds. The overall column height dimension 710 is a collective sum of both the column base height 650 and the turbine and brake system height 680. The brake system height 670 is dictated by the required scale needed to capture enough wind to drive a given size generator. A single turbine 170 can be scaled in size to drive any size generator, or as shown in FIG. 28 multiplicity of smaller turbines 170 can be stacked inline to produce an equal torque to a larger single turbine. The larger the turbine the larger its footprint, and in some cases this may not be an option. The modular column 700 system is a solution that permits wind energy utilization where other it could not be permitted.

When ideal, the systems geometry can be scaled up to any size needed to accommodate any level of kW energy production with no change in its functionality.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure.

1. A method of controlling and regulating the amount of wind that will interface with a turbine real time at varying winds speeds to increase convertible wind force at low winds speeds and maintain optimal turbine rpms at wind speeds normally above the safe capacity of the turbine generator and typically not converted into energy, and preventing damage to a wind turbine comprising the step of
providing a vertical wind turbine;
providing plurality of control blades pivotally mounted around the entire circumference of the vertical turbine;
connecting the control blades that regulates the open area as wind speeds to a control arm that increase and closes automatically when the wind speed reaches as chosen speed and rapidly reopens when the wind speed drops below chosen closure speed to the relative wind speed at the given moment constantly reacting and adjusting during wind gusts or sustained wind speeds.

2. A self-regulating wind amplifier and braking device for a vertical wind turbine comprising:
a vertical wind turbine turnably mounted on a first axle shaft, the wind turbine having a plurality of blades radially mounted around the axle shaft;
a plurality of pivotaly mounted control blades space radially outward from the vertical wind turbine blades and surrounding the vertical wind turbine
a control plate slidably mounted on a second axle shaft which is axially aligned with the first axle shaft, the control plate being biased to a chosen first position and a plurality of control arms attached to the perimeter of the control plate at a first end;
each of the control blades attached to a second end of one of the control arms, when the control plate is in its first position, the control blades are held in a corresponding first position;
a wind capture device movably attached above of the vertical wind turbine;
the control plate movably attached to the wind capture device such that the control plate is moved from the first position against the bias, in relation to the force of wind hitting the wind capture device, the bias causing the control plate to move back towards the first position automatically when the force of the wind decreases;
the moving of the control plate causes the control arms to pivot the control blades.

3. The self-regulating wind amplifier and braking device for a vertical wind turbine of claim 2 wherein the control plates are pivoted to a second, closed position when the wind capture device is impacted with a chosen force of wind, the closed position causing the control blades to completely enclose the vertical wind turbine.

4. A self-regulating wind amplifier and braking device for a vertical wind turbine of claim 2 wherein the control blades are pivotally mounted on a central longitudinal axis.

5. A self-regulating wind amplifier and braking device for a vertical wind turbine of claim 4, wherein the control arms are attached to the control blades on one side of the central longitudinal axis of the control blades.

6. A self-regulating wind amplifier and braking device for a vertical wind turbine of claim 4 wherein the control blade has first edge and a second edge, the first edge having a wing bent inward along its length and the second edge being formed by bending a plate the control blade is formed from under towards the longitudinal axis thereby forming a continuous wind flow surface along the second edge.

7. A self-regulating wind amplifier and braking device for a vertical wind turbine of claim 6, wherein the first edge of a control blade overlaps a second edge of an adjacent control blade when the control blades are in the closed position.

8. A self-regulating wind amplifier and braking device for a vertical wind turbine of claim 6 wherein the control arm is attached to wind flow surface.

9. A self-regulating wind amplifier and braking device for a vertical wind turbine of claim 2 wherein the first position of the control blades is chosen to direct a wind force impacting the control blades into the vertical wind turbine in a directed manor to optimize the force of the wind on the vertical wind turbine.

10. A self-regulating wind amplifier and braking device for a vertical wind turbine of claim 2, wherein as the control blades are moved between the first and closed position, the amount of wind force allowed to impact the blades of the vertical wind turbine is varied.

11. A self-regulating wind amplifier and braking device for a vertical wind turbine of claim 2, wherein the control arms are rigid rods.

12. A self-regulating wind amplifier and braking device for a vertical wind turbine of claim 2, wherein the control plate is moved downward toward the vertical wind turbine as the wind capture device is impacted by a larger amount of wind force.

13. A self-regulating wind amplifier and braking device for a vertical wind turbine of claim 2, wherein the wind capture device is biased in place such that the wind capture device does not actuate the control plate until the wind force is above a first chosen amount.

14. The self-regulating wind amplifier and braking device for a vertical wind turbine of claim 13 wherein the control plates are pivoted to a second, closed position when the wind capture device is impacted with a second chosen force of wind, the closed position causing the control blades to completely enclose the vertical wind turbine the second chosen force being higher than the first chosen force.
